(19) United States
(12) Patent Application Publication
(10) Pub. No.: US 2007/0269304 A1
(43) Pub. Date: Nov. 22, 2007

(54) Fluid rotor with energy enhancements power generation system

(76) Inventor: Donald E. Burg, Miami, FL (US)

Correspondence Address: Donald E. Burg, 15840 SW 84 Avenue, Miami, FL, 33157, US

(21) Appl. No.: 11/435,599

(22) Filed: May 17, 2006

(51) Int. Cl. F03D 7/06

(52) U.S. Cl. 415/4.2

(57) ABSTRACT

Presented is a physically and environmentally attractive fluid energy powered rotor driven power generation system that very efficiently extracts energy from both wind and water currents and that offers easy low cost manufacture, transportation, and installation due to its modular pre-fabricated design concepts. It achieves its high efficiencies by redirecting incoming fluids forward to add positive rotational energy to a side of the rotor what would otherwise have anti-rotational drag.

### BACKGROUND OF THE INVENTION

Means to extract energy from nature's wind and water currents have been many over the years as is evidenced from the prior art. The largest commercial units to current state-of-the-art technology are wind turbines with a horizontal axis and several very long and slender airfoil shaped blades. The overall height of some of these units exceeds 400 feet with the blades themselves over 120 feet long. While these blades are rather efficient since they convert wind energy to rotational energy during their entire cycle of rotation there are severe shortcomings. The gearbox and electrical generator are housed in a nacelle behind the blades with the nacelle as big as a school bus and weighting many tons. All of this is supported by a very heavy vertical structure. Control mechanisms must be incorporated so that the blades can be disengaged in very high winds. This makes for a large ungainly contraption that is expensive to build, install and maintain, environmentally noisy, hazardous to passing wildlife, and generally not nice to be around.

Attempts have been made at vertical axis wind turbines which have the advantage of locating the turbine and gears on the ground with the rotor above. These are generally more compact, less expensive, less noisy, and much less hazardous to passing wildlife. However they are inherently less efficient due to their rotor blade configurations. The wind energy is captured on the downwind rotational side or working side of the turbine blades in this most common approach. However, there is a force working against rotation that occurs when the blades rotate upwind during half of the rotor's rotation. The blades are generally swept backward in an attempt to reduce this negative rotational force. FIG. 1 of this application shows a generic version of a prior art vertical axis wind turbine rotor. Note how the force of the oncoming fluid is working against rotation when the blades are going upwind. The backward curved shape of the blades is designed to reduce as much as possible the negative rotational energy that occurs when the oncoming fluid impacts that side of the blade.

Examples of prior art vertical axis wind turbines with turbine blades similar in configuration to applicant's FIG. 1 include: Smedley, U.S. Pat. No. 6,242,818; Elder, U.S. Pat. No. 6,448,669; Tsipov, U.S. Pat. No. 6,962,478; Taylor et al., U.S. Pat. No. 6,966,747; and Rice, U.S. Pat. No. 6,984,899.

Applicant's instant invention addresses the shortcomings of both vertical and horizontal axis wind and water turbines in a highly efficient yet low cost and low maintenance design. This is accomplished by reversing direction of the passing fluid on what would normally be the upwind rotational side of the rotor so that such reverse directed fluid acts to generate positive rotational forces. In summary, the instant invention offers a low cost fluid energy converting power generation device that is more efficient than prior art vertical axis wind or water turbines. It does this while offering all of the advantages that a vertical axis rotor turbine generator has over state-of-the-art horizontal axis airfoil blade turbine generators.

A further feature of the instant invention is that it has been purposely conceived to be built in easily transportable pre-fabricated low cost modules. The pre-fabricated modules are very simple to assemble together as a complete wind or water current powered turbine generator. The advantages of the present invention will be understood upon review of the following sections.

### SUMMARY OF THE INVENTION

A primary object of the invention is to provide a fluid energy powered rotor driven power generation system that is highly efficient, physically and environmentally attractive, and low in cost.

A further object of the invention is that the fluid energy powered rotor have fluid energized rotor blades that extend outward from its rotational axis where the fluid energized rotor blades absorb energy from passing fluids that is then transmitted to a power generator for conversion to useful power.

It is a related object of the invention that the fluid energized rotor blades absorb energy from rearward flowing incoming fluid during a first portion of rotation of the fluid energy powered rotor and absorb energy from incoming fluid that has been at least partially redirected to be forward flowing over a second portion of rotation of said fluid energy powered rotor.

A directly related object of the invention is that redirection of the fluid flow to a forward direction be at least partially accomplished by fluid flow turning vanes.

Yet another object of the invention is that fluid flow separation means separate incoming fluid flow to opposite sides of the fluid energy powered rotor.

Another object of the invention is that it comprise frontal area increasing outward boundary means that increase the amount of incoming flow directed to the rotor blades.

Still another object of the invention is that it further comprise means to rotate an inlet to the fluid energy powered rotor to a direction in alignment with oncoming fluids.

A directly related object of the invention is that means to rotate an inlet to the fluid energy powered rotor include a powered actuator.

Yet another object of the invention is that a disconnect mechanism be positioned between the power generator and the fluid energy powered rotor.

An important cost saving object of the invention is that it be composed of pre-fabricated modules.

A directly related object of the invention is that the pre-fabricated modules include a base module and one or more rotor modules.

A further related object of the invention is that onto the stationary base module is mounted a rotatable base module onto which is mounted a fluid energy powered rotor module.

A related object of the invention is that energy to rotate the base module be supplied by a powered actuator.

Yet another object of the invention is that the fluid energized rotor blades are, at least in part, concave on the surface receiving incoming fluids and convex on the opposite surface.

A further object of the invention is that the fluid energized rotor blades, as seen looking at an end of the rotor, may be twisted.

It is a further object of the invention that it may be configured such that fluid energy powered rotors are disposed either side of a common power generator with said fluid powered rotors driving the common power generator.

It is a related object of the invention that it may further comprise second fluid energy powered rotors disposed either side of a second common power generator with said second fluid energy powered rotors driving the second common power generator.

It is a further related object of the invention that fluid powered rotors disposed either side of a common power generator are rotatable about a common base.

### BRIEF DESCRIPTION OF THE DRAWINGS

FIG. 1 is a cross-section of a prior art fluidal rotor that is being rotationally driven by approaching fluids. This is the arrangement of some vertical axis windmills or wind turbines. Note that the driving fluid is pushing on the rotor blades on the downwind or working part of rotation and acting against rotation on the upwind part of rotation. The rotor blades have been angled backward or, as more commonly termed, backward inclined in efforts to reduce the parasitic rotational drag that occurs during upwind rotation.

FIG. 2 presents a cross-section, as taken through plane 2-2 of FIGS. 6 and 10, of a preferred embodiment fluid rotor and related structure to the instant invention. Note that: 1) More incoming fluid is directed toward the rotor due to the enlarged capture area forward of the rotor and 2) Incoming fluid that would normally work against rotation on the upwind side of rotation has been redirected so that it adds positively to rotational force rather than creating a parasitic rotational drag force as is the case for the prior art rotor presented in FIG. 1.

FIG. 3 presents a cross section of a mounting base assembly including a power generator. Coupled to that is an adapter assembly including gearing to a preferred embodiment of the invention.

FIG. 4 is a cross section, as taken through plane 4-4 of FIG. 3, that shows workings of gears that drive the power generator. Note that, while an electric generator is most common, any type of power generator including hydraulic or other may be used to absorb the rotational power from the turbine rotor(s).

FIG. 5 shows an end view of a rotor assembly module to a preferred embodiment of the instant invention.

FIG. 6 gives a side view of the rotor assembly module of FIG. 5.

FIG. 7 is an end view of a cover to a preferred embodiment of the instant invention.

FIG. 8 presents a side view of the cover of FIG. 6.

FIG. 9 gives an end view, in this case a top view, of an assembled and functional Fluid Rotor with Energy Enhancement (FREE) Power Generation System to a preferred embodiment of the invention.

FIG. 10 is a side view of an assembled and functional unit to the invention. In this instance, two rotor modules have been employed. Note that any number of rotor modules may be used.

FIG. 11 presents a front view of the assembled unit. Note the simple construction of this pre-fabricated unit. The base (A), normally including the power generator, is first set in concrete or a similar material; the geared adapter housing assembly (B) is installed next, followed by one, two, or more rotor module assemblies (C), and then an end cap (D). This pre-fabrication approach of the instant invention allows for very low cost fabrication, shipping, and assembly.

FIG. 12 shows an end, or in this case top, view of a rotor with straight blades.

FIG. 13 gives a side view of the rotor of FIG. 12.

FIG. 14 is an end view of a twisted or curved version of a rotor to the instant invention.

FIG. 15 is a side view of the twisted rotor presented in FIG. 14. Note that the twisted rotor variant offers some advantage in structural rigidity and, in some instances, efficiency over the straight blade design.

FIG. 16 shows and alternative approach where a number of rotor modules may be mounted side by side and end to end to create a very large and efficient capture area to oncoming fluids. Note that, in the this preferred embodiment, the entire assembled unit may rotate around a common base.

FIG. 17 gives an internal view of connecting structure that houses a double ended power generator in this instance.

FIG. 18 is a cross section, as taken through plane 18-18 of FIG. 17, that shows details of a mount base and adapter housing that cradles two power generators.

FIG. 19 presents a cross section, as taken through plane 19-19 of FIG. 16, that shows an end support.

FIG. 20 is a cross section, as taken through plane 20-20 of FIG. 19, showing bearing supports internal to end support.

### DETAILED DESCRIPTION

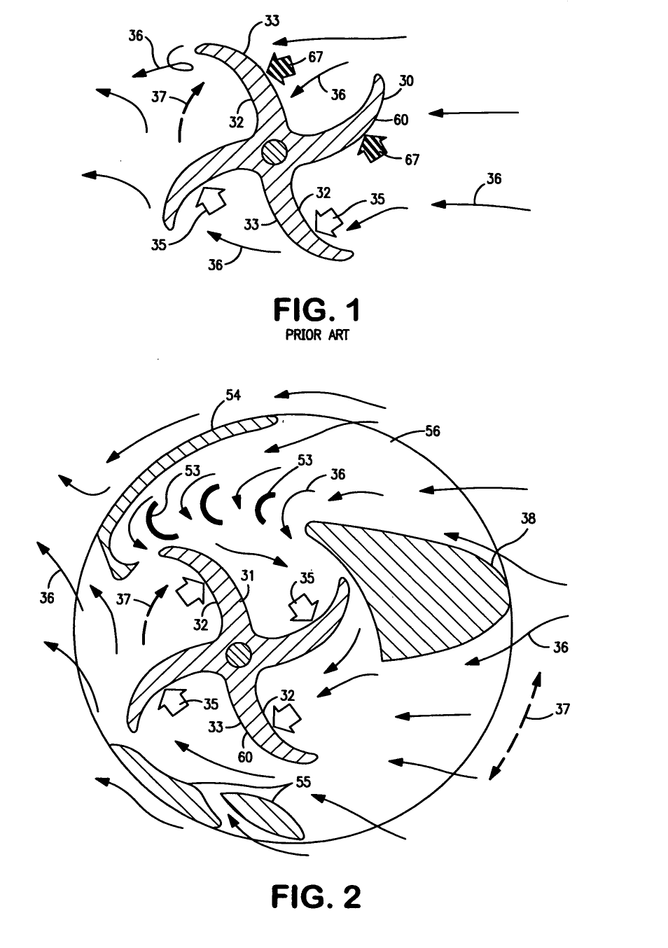

FIG. 1 is a cross-section of a prior art fluid rotor 30 that is being rotationally driven, as indicated by rotation arrow 37, by approaching fluids that are indicated by fluid flow arrows 36. This is the arrangement of some vertical axis windmills or wind turbines. Note that the driving fluid is pushing on the rotor blades 60 on the downwind or working part of rotation as shown by force arrows 35 on rotor blade working sides 32 that are generally concave in shape. These oncoming fluid forces are acting against rotation, as indicated by anti-rotation or rotational parasitic drag force arrows 67, on the upwind part of rotor rotation where they act against what is generally termed the rotor blade non-working side 33 that is normally convex in shape. It is evident from the immediately preceding discussion that the rotor blades 60 have been angled backward or, as sometimes termed, backward inclined in efforts to reduce the parasitic rotational force drag that occurs during upwind rotation.

FIG. 2 presents a cross-section, as taken through plane 2-2 of FIGS. 6 and 10, of a preferred embodiment fluid rotor 31 and related structural to the instant invention. Note that: 1) More incoming fluid is directed toward the rotor 31 due to the enlarged capture area forward of the rotor 31 and 2) Incoming fluid that would normally work against rotation on the upwind side of rotation has been redirected so that it adds positively to rotational force rather than creating a parasitic rotational drag force as is the case for the prior art rotor 30 presented in FIG. 1. This can be seen by looking at the force vector arrows 35 that are all providing positive rotational energy here. This compares to the prior art rotor 30 presented in FIG. 1 where the rotational parasitic drag force arrows 67 are working against rotation on the upwind side of rotation.

Looking at FIG. 2 in more detail, we have, as an optimum shape, an airfoil shaped nose cone structure 38 that smoothly directs and accelerates incoming fluids, positive rotation side capture plate(s) 55, 61, negative rotation side capture plate 54, and fluid turning or redirecting vane(s) 53. By use this or another arrangement whereby the negative rotation side incoming fluid flow is redirected forward, we are able to have positive rotational energy impacting both sides of the rotor. This contrasts to the prior art presented in FIG. 1 whereby there is a negative or parasitic drag during the rotor blades upwind rotation. The optional flow passageway 62 provides an inlet to direct more positive direction incoming fluid flow 36 to the rotor blades 31.

FIG. 3 presents a cross section of a mounting base assembly (A) 47 including a power generator 39. On top of that is an adapter assembly or module (B) 48 that normally includes gearing 42 that drives the generator gear 40. The procedure for assembly at a site is to first position and set the mounting base assembly (A) 47 in concrete or other material. The generator 39 and bearings 43 are then set into place. At that point the adapter module 43 is aligned and put in place. Other items shown are shaft bearing 51, seals 63, and rotational drive motor and gear 41.

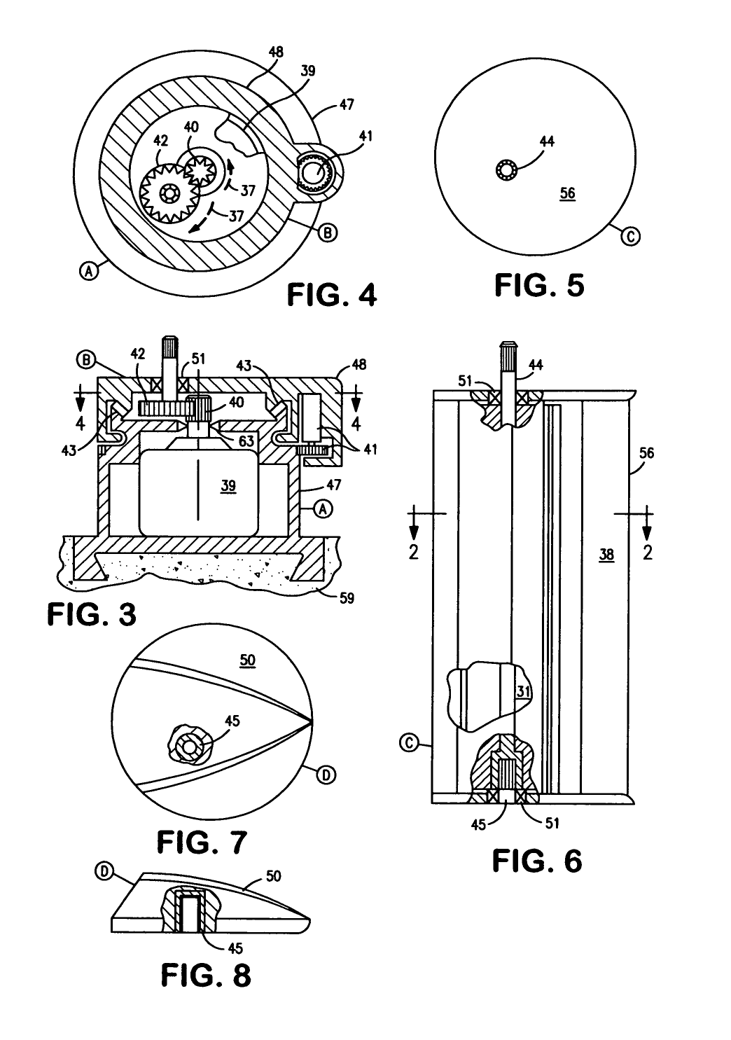

FIG. 4 is a cross section, as taken through plane 44 of FIG. 3, that shows workings of gears 42 that drive the power generator gear 40. Note that, while an electric generator is most common, any type of power generator 39 including hydraulic or other may be used to absorb the fluid power from the turbine rotor(s). Further, it may be desirable to incorporate a disconnect clutch, not shown, so that the power generator 39 may be disengaged for maintenance or during very high fluid velocity situations, such as may occur in windstorms. It is important to note that the instant invention may be utilized with any fluid media. This means that, in additional to use as a wind turbine, it may be used as a water turbine in rivers, the Gulf Stream, or the like.

FIG. 5 shows an end view of a rotor assembly module (C) 56 including a splined drive shaft 44 to a preferred embodiment of the instant invention.

FIG. 6 gives a side view of the rotor assembly module (C) 56 presented in FIG. 5. Cutaway views show shaft support bearings 51, female spline adapter 45, and male spline adapter 44. A further cutaway view shows portions of a rotor 31.

FIG. 7 is an end view of a cover (D) 50 including a female bearing adapter 45 to a preferred embodiment of the instant invention.

FIG. 8 presents a side view of the cover (D) 50 of FIG. 6.

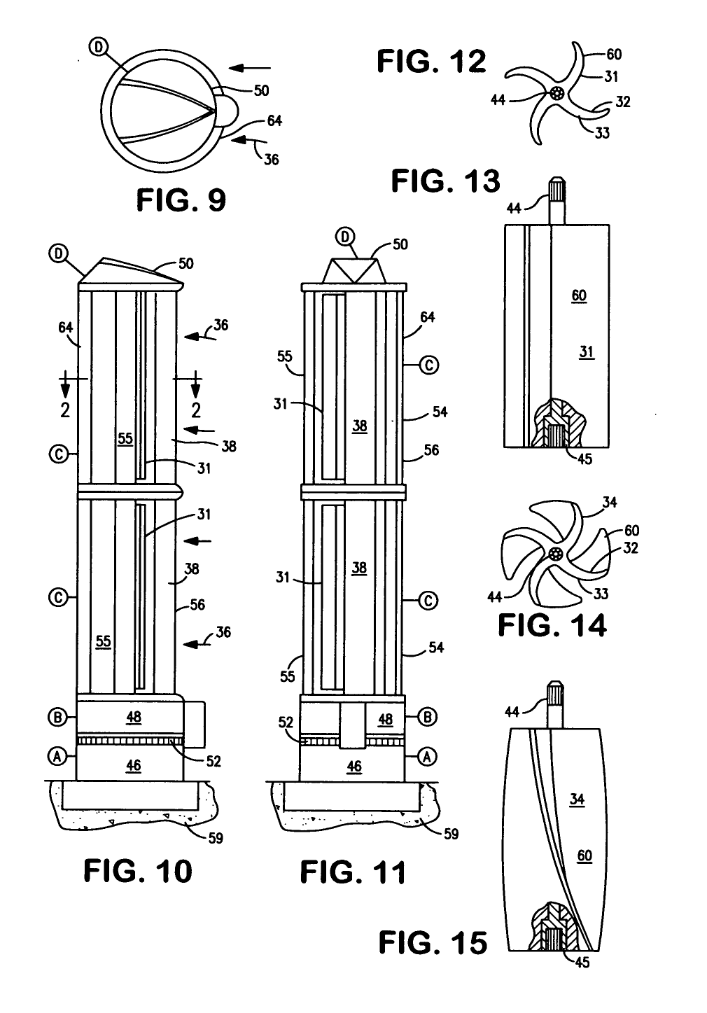

FIG. 9 gives an end view, in this case a top view, of an assembled and functional Fluid Rotor with Energy Enhancement (FREE) Power Generation System 64 to a preferred embodiment of the invention.

FIG. 10 gives a side view of an assembled and functional FREE Power Generation System 64 to the instant invention. In this instance, two rotor modules (C) 56 have been employed. Note that any number of rotor modules (C) 56 may be employed. A gear track 52 used during rotation of the FREE Power Generation System 64 is also shown here. Direction of fluid flow is indicated by fluid flow arrows 36.

FIG. 11 presents a front view of an assembled FREE Generator 64. Note the simple construction of this pre-fabricated unit. The base (A) 46, normally including the power generator, is first set in concrete or a similar material; the geared adapter housing assembly (B) 48 is installed next, followed by one, two, or more rotor module assemblies (C) 56, and then an end cap (D) 50. This pre-fabrication approach of the instant invention allows for very low cost fabrication, shipping, and assembly. Further, it is physically and environmentally acceptable and attractive.

FIG. 12 shows an end, or top, view of a rotor 31 with longitudinally straight blades 60.

FIG. 13 is a side view of the rotor 31 of FIG. 12 with a cutaway showing a female drive spline 45. A preferred rotor construction for wind turbine rotors utilizes a lightweight high strength composite material skin with an internal filling of structural foam. In the case of water turbines, it is generally preferred to use a corrosion resistant sheet metal construction.

FIG. 14 is an end view of an optional twisted or curved rotor 34 to the instant invention.

FIG. 15 is a side view of the twisted rotor 34 presented in FIG. 14. The twisted rotor 34 offers some structural advantages and possibly efficiency over the straight blade design.

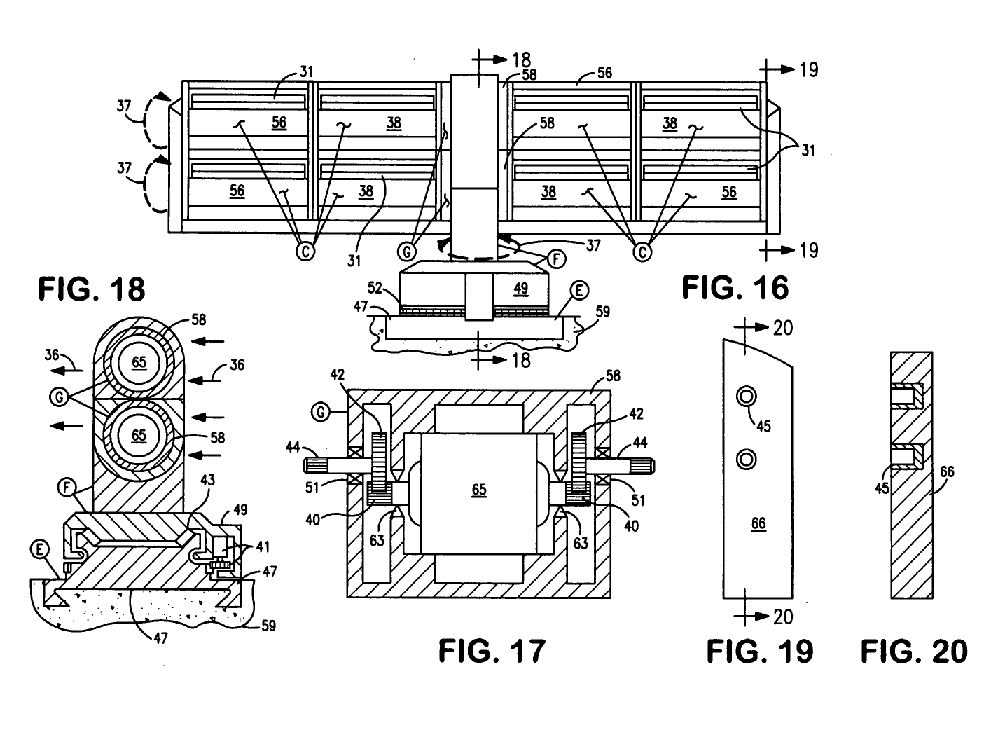

FIG. 16 shows an alternative approach where a number of rotor modules (C) 56 may be mounted side by side and/or end to end to create a very large and efficient oncoming fluid capture area. In this embodiment, the entire assembled unit may rotate around a common base 49 as indicated by rotation arrow 37. In the case of a water turbine version for use in such more or less constant flow direction water flows, such as in the Gulf Stream, it is not necessary to have a rotatable base.

FIG. 17 gives an internal view of connecting structure (G) 58 that houses double ended power generators 65 in this instance.

FIG. 18 is a cross section, as taken through plane 18-18 of FIG. 17, that shows details of a mount base (E) 47 and adapter housing (F) 49 that cradles two double ended power generators 65.

FIG. 19 is a cross section, through plane 19-19 of FIG. 16, showing an end support 66.

FIG. 20 is a cross section, as taken through plane 20-20 of FIG. 19, showing bearing supports 45 internal to end support 66.

While the invention has been described in connection with a preferred and several alternative embodiments, it will be understood that there is no intention to thereby limit the invention. On the contrary, there is intended to be covered all alternatives, modifications, and equivalents as may be included within the spirit and scope of the invention as defined by the appended claims, which are the sole definition of the invention.

What I claim is:

1. In a fluid energy powered rotor driven power generation system with said fluid energy powered rotor having fluid energized rotor blades that extend outward from a rotational axis of said fluid energy powered rotor wherein said fluid energized rotor blades absorb energy from passing fluids with said energy transmitted to a power generator for conversion to useful power, the improvement comprising:
said fluid energized rotor blades absorb energy from rearward flowing incoming fluid during a first portion of rotation of said fluid energy powered rotor and absorb energy from incoming fluid that has been at least partially redirected by fluid flow turning means to be forward flowing over a second portion of rotation of said fluid energy powered rotor thereby providing positive rotational energy over a majority of the rotation of the fluid energy powered rotor.

2. The fluid energy powered rotor driven power generation system of claim 1 wherein said fluid flow turning means includes fluid flow turning vanes.

3. The fluid energy powered rotor driven power generation system of claim 1 which further comprises flow separation means wherein said flow separation means separates incoming fluid flow to opposite sides of the fluid energy powered rotor.

4. The fluid energy powered rotor driven power generation system of claim 1 which further comprises frontal area increasing outward boundary means that increase the amount of incoming flow directed to the fluid energized rotor blades.

5. The fluid energy powered rotor driven power generating system of claim 4 wherein said frontal area increasing outward boundary means includes stationary curvilinear elements.

6. The fluid energy powered rotor driven power generation system of claim 1 which further comprises means to rotate an inlet to the fluid energy powered rotor to a direction in alignment with oncoming fluids.

7. The fluid energy powered rotor driven power generation system of claim 6 wherein said means to rotate an inlet to the fluid powered rotor includes a powered actuator.

8. The fluid energy powered rotor driven power generation system of claim 1 wherein a disconnect mechanism is positioned between the power generator and the fluid energy powered rotor.

9. The fluid energy powered rotor driven power generation system of claim 1 wherein said fluid energy powered rotor driven power generation system includes pre-fabricated modules.

10. The fluid energy powered rotor driven power generation system of claim 9 wherein said pre-fabricated modules include a base module and one or more rotor modules.

11. The fluid energy powered rotor driven power generation system of claim 1 wherein said fluid energized rotor blades are, at least in part, concave on a surface receiving incoming fluids and convex on an opposite surface.

12. The fluid energy powered rotor driven power generation system of claim 1 wherein said fluid energized rotor blades, as seen looking at an end of the rotor, are twisted.

13. In a fluid energy powered rotor driven power generation system with said fluid energy powered rotor having fluid energized rotor blades that extend outward from a rotational axis of said fluid energy powered rotor wherein said fluid energized rotor blades absorb energy from passing fluids with said energy transmitted to a power generator for conversion to useful power, the improvement comprising:
a base module upon which is mounted a rotatable fluid energy powered rotor module and wherein energy to rotate the rotatable fluid energy powered rotor module is supplied by a powered actuator and wherein said rotatable fluid energy powered rotor module is rotated such that a fluid inlet of the fluid powered rotor module is in alignment with oncoming fluids and which further comprises fluid flow turning means disposed to redirect rearward flowing incoming fluid to forward flowing fluid prior to said fluid contacting the fluid energized rotor blades.

14. The fluid energy powered rotor driven generator system of claim 13 wherein said fluid energized rotor blades absorb energy from rearward flowing incoming fluid during a first portion of rotation of said fluid energy powered rotor and absorb energy from the incoming fluid that has been at least partially redirected to be forward flowing over a second portion of rotation of said fluid energy powered rotor.

15. The fluid energy powered rotor driven power generation system of claim 14 wherein said fluid flow turning means includes fluid flow turning vanes.

16. In a fluid energy powered rotor driven power generation system with said fluid energy powered rotor having fluid energized rotor blades that extend outward from a rotational axis of said fluid energy powered rotor wherein said fluid energized rotor blades absorb energy from passing fluids with said energy transmitted to a power generator for conversion to useful power, the improvement comprising:
fluid energy powered rotors disposed either side of a common power generator with said fluid powered rotors driving the common power generator and which further comprises fluid flow turning means disposed to redirect at least part of rearward flowing incoming fluid to forward flowing fluid prior to said fluid contacting the fluid energized rotor blades.

17. The fluid energy powered rotor driven generator system of claim 16 wherein said fluid energized rotor blades absorb energy from rearward flowing incoming fluid during a first portion of rotation of said fluid energy powered rotor and absorb energy from the incoming fluid that has been at least partially redirected to be forward flowing over a second portion of rotation of said fluid energy powered rotor.

18. The fluid energy powered rotor driven power generation system of claim 16 wherein said fluid flow turning means includes fluid flow turning vanes.

19. The fluid energy powered rotor driven power generation system of claim 16 which further comprises flow separation means wherein said flow separation means separate incoming fluid flow to opposite sides of the fluid powered rotor.

20. The fluid energy powered rotor driven power generation system of claim 16 which further comprises frontal area increasing outward boundary means that assist in increasing an amount of incoming fluid flow directed to the rotor blades.

21. The fluid energy powered rotor driven power generation system of claim 16 which further comprises second fluid energy powered rotors disposed either side of a second common power generator with said second fluid energy powered rotors driving the second common power generator.

22. The fluid powered rotor driven power generation system of claim 16 wherein said fluid powered rotor driven power generation system is rotatable about a common base.
